(19) United States
(12) Patent Application Publication
(10) Pub. No.: US 2018/0059072 A1
(43) Pub. Date: Mar. 1, 2018

(54) HIGH PERFORMANCE LIQUID CHROMATOGRAPHY METHOD FOR ANALYSIS OF MN DIAGNOSTIC AND THERAPEUTIC LIGAND AND PRECURSOR

(71) Applicant: INSTITUTE OF NUCLEAR ENERGY RESEARCH, ATOMIC ENERGY COUNCIL, EXECUTIVE YUAN, P.R.C., TAOYUAN COUNTY (TW)

(72) Inventors: KUEI-LIN LU, TAOYUAN COUNTY (TW); JIA-DONG TSAI, TAOYUAN COUNTY (TW); YU CHANG, TAOYUAN COUNTY (TW); CHENG-FANG HSU, TAOYUAN COUNTY (TW)

(21) Appl. No.: 15/254,118

(22) Filed: Sep. 1, 2016

(51) Int. Cl. G01N 30/34; G01N 30/74; B01D 15/38; B01D 15/42

(52) U.S. Cl. CPC G01N 30/34; G01N 30/74; G01N 2030/342; B01D 15/426; B01D 15/3828

(57) ABSTRACT

A high performance liquid chromatography method for analysis of a MN diagnostic and therapeutic ligand and precursors is revealed. Polarity of eluents used during elution is changed to remove impurities. First use a first eluent with a lower ratio of acetonitrile as a mobile phase to elute analytes. Then a second eluent in which a ratio of acetonitrile is increased into 97˜99% is used to elute the analytes for at least 20 minutes. Next use the first eluent to elute the analytes for at least 60 minutes. Thus no residual impurities are left in the column and the analytes remain in the column stably. Therefore a more accurate and reproductive result is obtained.

### BACKGROUND OF THE INVENTION

### Field of the invention

The present invention relates to an analytical method, especially to a high performance liquid chromatography method for analysis of a MN diagnostic and therapeutic ligand, and MN diagnostic and therapeutic ligand precursors.

### Descriptions of Related Art

Among cancer patients, liver cancer is more common than other cancers. The factors that induce liver cancer include chronic hepatitis B, chronic hepatitis C, alcoholic hepatitis, non-alcoholic fatty liver disease, etc. The liver cancer patients are distributed over various areas including Asia, Africa, and American. Thus the liver cancer has become a major public health problem worldwide.

The latest liver cancer treatment options include surgery, chemotherapy, radiotherapy, transcatheter arterial embolization, etc. Most patients at early stage without liver cirrhosis are treated by surgery while patients having liver cirrhosis are treated by orthotopic liver transplantation. The rest patients unable to have surgery owing to liver cirrhosis and not qualified for transplantation need effective alternative treatments. In recent years, a new drug, ¹⁸⁸ReO-MN-16-Et, with great potential in treatment of liver cancer has been developed. H3-MN-16-Et is used as a ligand to react with radioactive ¹⁸⁸Re and get ¹⁸⁸ReO-MN-16-Et. Then ¹⁸⁸ReO-MN-16-Et is dissolved in Lipiodol to get radioactive drug ¹⁸⁸ReO-MN 16-Et/Lipiodol used for diagnosis and treatment of the disease.

The non-radioactive standard for ¹⁸⁸ReO-MN-16-Et is ReO-MN-16-Et. The production of ReO-MN-16-Et includes a plurality of steps. Not every intermediate or precursor of the step can be analyzed by high performance liquid chromatography (HPLC). The results of the few analysis methods available now are lack of reproducibility because low-polarity impurities are unable to be washed out during analysis.

The conventional technique uses a solvent containing a fixed ratio of components as an eluent so that the equilibration time can be shortened and samples can be input and analyzed continuously. Yet impurities with low polarity are unable to be detected because the impurities are unable to be eluted from the chromatography column by the mobile phase with relatively low polarity. Once the HPLC purity is calculated based on the area percentage, the purity is always overestimated without considering the existence of the impurities with low polarity. On the other hand, the impurities with low polarity residual in the chromatography column may obstruct the flow through the column or affect the following HPLC analysis. Thus the purity is underestimated. Thus there is a need to develop a new high performance liquid chromatography method for solving the problems mentioned above.

Based on the concept of “gradient elution” mentioned in the Taiwanese Pat. App. No. 104131957, the above problems of the impurities with low-polarity including effect on the accuracy of the analysis and residues in the column can be solved. However, the mobile phase/eluent used in this prior art is not compatible with the protective agents used during preparation of MN diagnostic and therapeutic ligand. Thus there is room for improvement of the method in order to be applied to the analysis of MN diagnostic and therapeutic ligand and its precursors.

### SUMMARY OF THE INVENTION

Therefore it is a primary object of the present invention to provide a high performance liquid chromatography method for analysis of a MN diagnostic and therapeutic ligand and precursors in which a solution containing a high ratio of acetonitrile is used to wash low-polarity impurities from the column. Thus accuracy of the analysis is ensured and the possibility of the impurities residual in the column is reduced.

It is another object of the present invention to provide a high performance liquid chromatography method for analysis of a MN diagnostic and therapeutic ligand and precursors in which ultraviolet light with a wavelength of 210 nm is used to detect most of molecules eluted and the accuracy of area percentage of the detection signal is improved.

It is another object of the present invention to provide a high performance liquid chromatography method for analysis of a MN diagnostic and therapeutic ligand and precursors in which a concept of gradient elution is revealed. That means impurities in the column are washed out by eluents with changes in polarity. Thus the reliability of the analysis result is increased.

In order to achieve the above objects, a high performance liquid chromatography method for analysis of a MN diagnostic and therapeutic ligand and precursors according to the present invention includes a plurality of steps. The MN diagnostic and therapeutic ligand is N-(2-thioethyl)-3-aza-19-ethyloxycarbonyl-3-(2-thioethyl)-octadecanamido]oxorhenium while the MN diagnostic and therapeutic ligand precursors include 2-[(Triphenylmethyl)thio]ethylamine, N-[2-((Triphenylmethyl-)thio)ethyl]chloroacetamide, N-[2-((Triphenylmethyl)thio)-ethyl] [2-((triphenylmethyl)thio)ethylamino]acetamide and N-[2-((Triphenylmethyl)thio)ethyl]-3-aza-18-ethyloxy-carbonyl-3-[2-((triphenylmethyl)thio)-ethyl]octadecan-amide. First place a MN diagnostic and therapeutic ligand or a MN diagnostic and therapeutic ligand precursor into a chromatography column. Then run a mobile phase elution of the MN diagnostic and therapeutic ligand or the MN diagnostic and therapeutic ligand precursor and use an ultraviolet (UV) detector to record a chromatogram during the mobile phase elution. Both the first eluent and the second eluent include acetonitrile and a trifluoroacetic acid solution while a volume ratio of the acetonitrile in the second eluent is higher than a volume ratio of the acetonitrile in the first eluent.

The weight percent of the trifluoroacetic acid solution is ranging from 0.1% to 1%.

The volume ratio of the acetonitrile in the first eluent is 35˜85%.

The volume ratio of the acetonitrile in the second eluent is 97˜99%.

The flow rate in the mobile phase elution is ranging from 0.5 ml/min to 1 ml/min.

In the mobile phase elution, the first eluent is used to elute the MN diagnostic and therapeutic ligand or the precursor for at least 20 minutes.

In the mobile phase elution, the second eluent is used to elute the MN diagnostic and therapeutic ligand or the precursor for at least 20 minutes.

In the mobile phase elution, lastly the first eluent is used again to elute the MN diagnostic and therapeutic ligand or the precursor for at least 60 minutes.

The detection wavelength of the UV detector is 210 nm.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a flow chart showing steps of an embodiment according to the present invention;

FIG. 2 is a chromatogram of an embodiment according to the present invention;

FIG. 3 is a chromatogram of an embodiment according to the present invention;

FIG. 4 is a chromatogram of an embodiment according to the present invention;

FIG. 5 is a chromatogram of an embodiment according to the present invention; and

FIG. 6 is a chromatogram of an embodiment according to the present invention.

### DETAILED DESCRIPTION OF THE PREFERRED EMBODIMENT

In order to learn functions and features of the present invention, please refer to the following embodiments and the detailed descriptions.

The present invention provides a high performance liquid chromatography method for analysis of a MN diagnostic and therapeutic ligand and precursors in which impurities with low-polarity are washed from a chromatography column by changing polarity of eluents. Compared with being eluted by the eluent having the same polarity, the possibility of the low-polarity impurities residual in the chromatography column is reduced. Thereby accuracy and reliability of the analysis are improved. Thus the following analysis will not be affected by residual impurities and the chromatography column has extended service life.

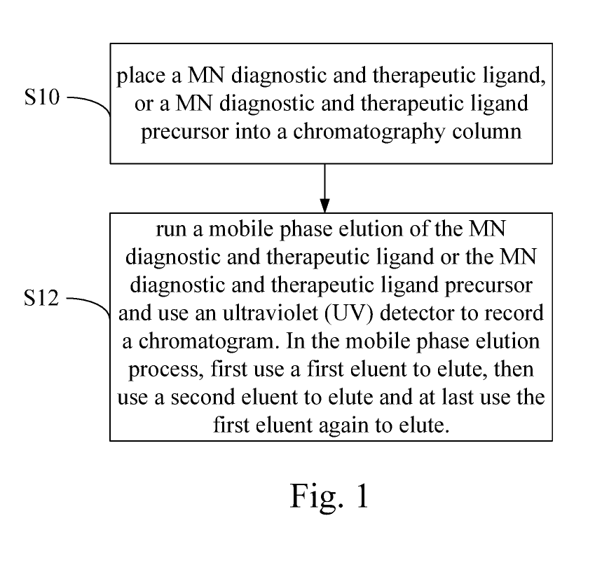

Refer to FIG. 1, a high performance liquid chromatography for analysis of a MN diagnostic and therapeutic ligand comprising the steps of:

Step S10: place a MN diagnostic and therapeutic ligand, or a MN diagnostic and therapeutic ligand precursor into a chromatography column; and

Step S12: run a mobile phase elution of the MN diagnostic and therapeutic ligand or the MN diagnostic and therapeutic ligand precursor and use an ultraviolet (UV) detector to record a chromatogram. In the mobile phase elution process, first use a first eluent to elute, then use a second eluent to elute and at last use the first eluent again to elute.

During the elution, the eluent used is not with a fixed polarity. First use a first eluent as a mobile phase to elute analytes for at least 20 minutes. The first eluent includes 35˜85% (v/v) acetonitrile. Then use a second eluent in which the volume ratio of acetonitrile is increased into 97˜99% as a mobile phase to elute the analytes for at least 20 minutes. Next use the first eluent again to elute for at least 60 minutes to make the high performance liquid chromatography system turn back to the original state stably. The timing for users to replace the first eluent by the second eluent depends on detection results of the UV detector that detects the MN diagnostic and therapeutic ligand or the MN diagnostic and therapeutic ligand precursor being eluted by the first eluent. After the target material being detected by ultraviolet light having a wavelength of 210 nm and a signal being generated, the first eluent is replaced by the second eluent and the second eluent is used as a mobile phone to elute.

Ultraviolet light having a wavelength of 210 nm is used for detection in the present invention. The area percentage of the absorption signal of the main component obtained is getting closer to the actual state. The benzene derivatives generally have absorption signal at the wavelength of 254 nm. Thus biomedical tests are commonly detected at 254 nm. However, not all impurities include the benzene ring. Thus not all impurities can be detected at 254 nm to get the absorption signal. The detection wavelength used in present invention is 210 nm for detection of most of the molecules. Thus the accuracy of the area percentage of the absorption signal is improved.

In the above steps, the MN diagnostic and therapeutic ligand and its precursors are used as embodiments. The chromatography column used is Merck Chromolith RP-18e (100 mml*4.6 mmOD). The present method can be applied to analysis of final products or precursors during preparation process of ReO-MN-16-Et.

Before the step S10, a MN diagnostic and therapeutic ligand or a MN diagnostic and therapeutic ligand precursor has been prepared by the production process and techniques available now. The MN diagnostic and therapeutic ligand, ReO-MN-16-Et, is prepared by a synthesis pathway including the following reaction 1, reaction 2 and reaction 3.

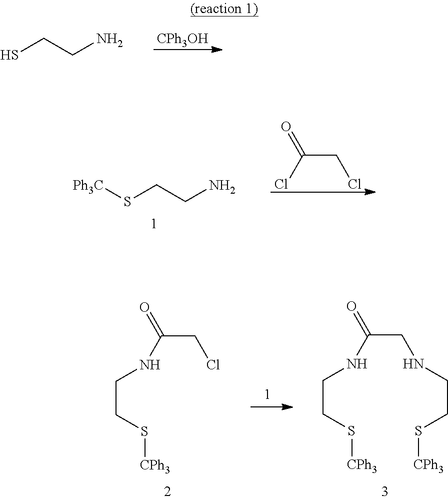

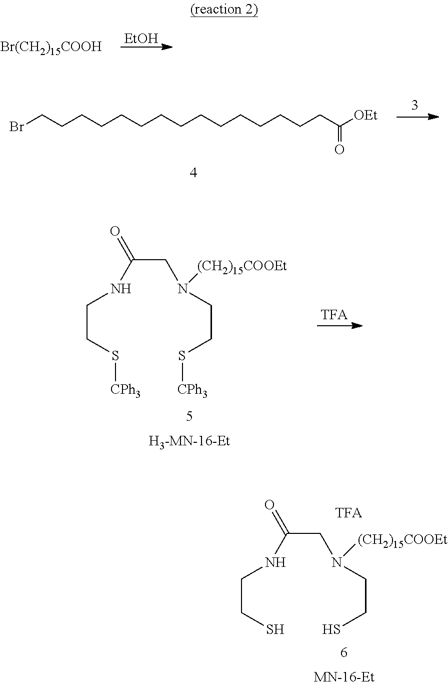

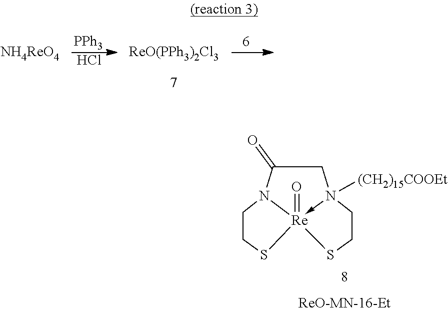

Take the precursor 1 in the reaction 1 as an example, it's 2-[(Triphenylmethyl)thio]ethylamine and having a structural formula:

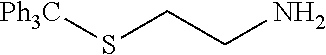

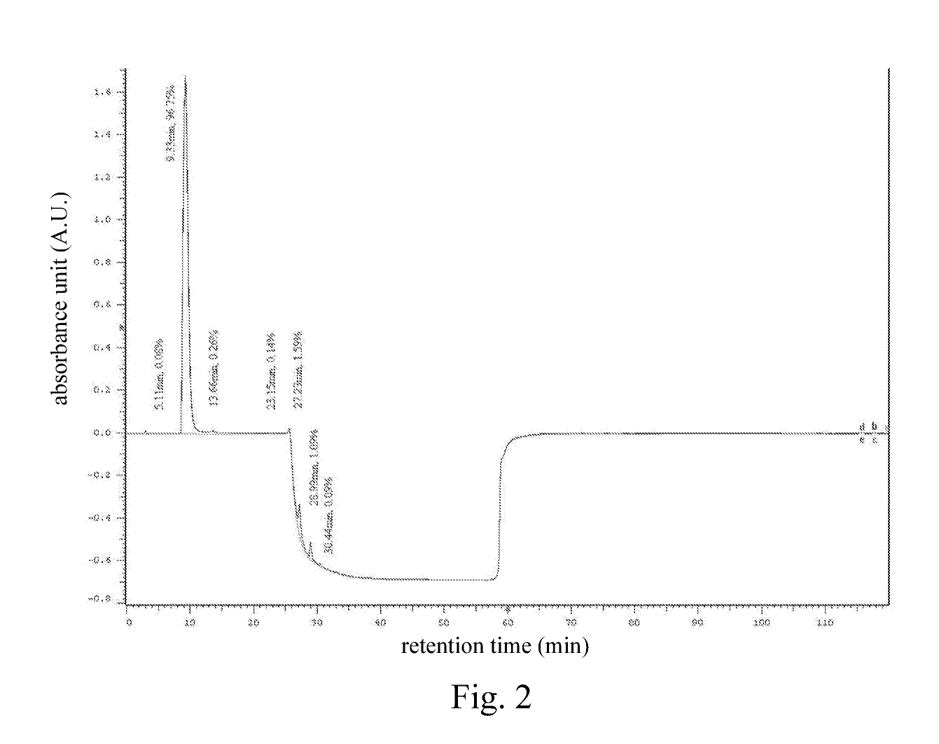

The analysis of the precursor 1 is carried out in a 2.0 ml brown vial. First weight 3.7 mg precursor 1 and add 1.8 ml acetonitrile (HPLC). Firstly use 35% acetonitrile/65%, 0.1% trifluoroacetic acid solution as a first eluent and wait for 20 minutes. Then the first eluent is replaced by a second eluent containing 99% acetonitrile/1%, 0.1% trifluoroacetic acid solution in 60 seconds and wait for 30 minutes. Next the second eluent is replaced by the first eluent, 35% acetonitrile/65%, 0.1% trifluoroacetic acid solution, in 60 seconds and wait for 68 minutes. The retention time of the main signal (the precursor 1) is about 9.33 minutes. Please refer to the following table 1 and the chromatograph shown in FIG. 2.

TABLE 1

| precursor 1 | 0.0 Min | 20.0 min | 21.0 min | 51.0 min | 52.0 Min | 120.0 min |
|---|---|---|---|---|---|---|
| 0.1% tri- | 65% | 65% | 1% | 1% | 65% | 65% |
| fluoroacetic | | | | | | |
| acid | | | | | | |
| solution | | | | | | |
| acetonitrile | 35% | 35% | 99% | 99% | 35% | 35% |
| (HPLC) | | | | | | |
| flow rate | 0.5 ml/min | 0.5 ml/min | 0.5 ml/min | 0.5 ml/min | 0.5 ml/min | 0.5 ml/min |
| wavelength | 210 nm | 210 nm | 210 nm | 210 nm | 210 nm | 210 nm |

Take the precursor 2 in the reaction 1 as an example, it's N-[2-((Triphenylmethyl)thio)ethyl]chloro-acetamide and having a structural formula:

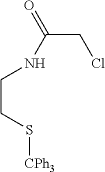

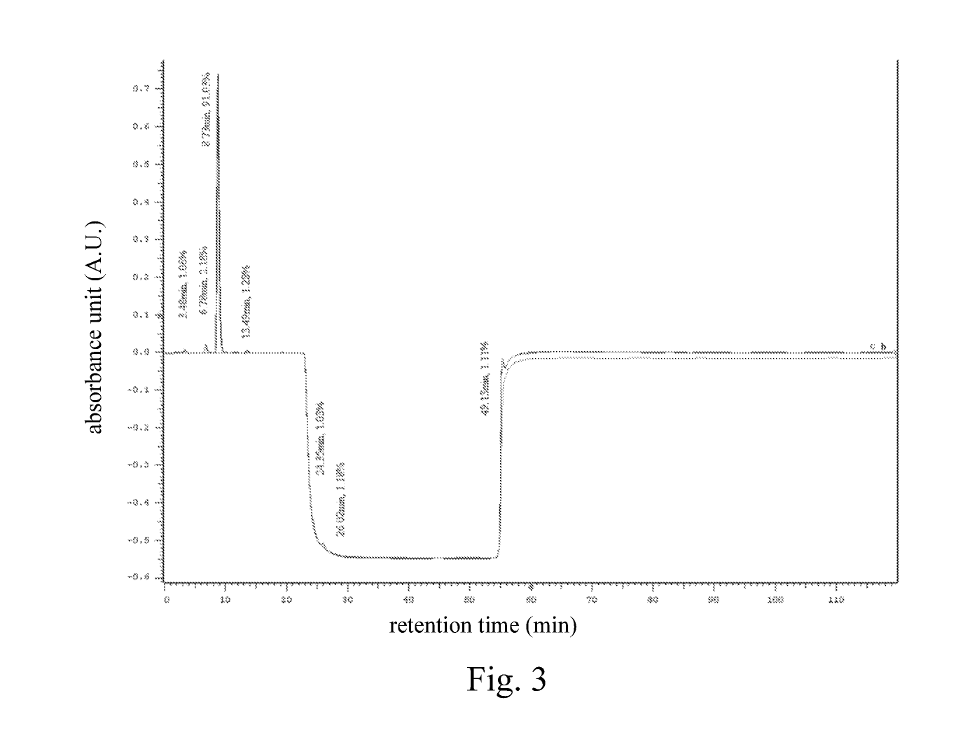

The analysis of the precursor 2 is performed in a 2.0 ml brown vial. First weight 3.3 mg precursor 2 and add 1.8 ml acetonitrile (HPLC). Firstly use 50% acetonitrile/50%, 0.1% trifluoroacetic acid solution as a first eluent and wait for 20 minutes. Then the first eluent is replaced by a second eluent containing 99% acetonitrile/1%, 0.1% trifluoroacetic acid solution in 60 seconds and wait for 30 minutes. Next the second eluent is replaced by the first eluent, 50% acetonitrile/50%, 0.1% trifluoroacetic acid solution, in 60 seconds and wait for 68 minutes. The retention time of the main signal (the precursor 2) is about 8.73 minutes. Please refer to the following table 2 and the chromatograph shown in FIG. 3.

TABLE 2

| precursor 2 | 0.0 Min | 20.0 min | 21.0 min | 51.0 min | 52.0 Min | 120.0 min |
|---|---|---|---|---|---|---|
| 0.1% tri- | 50% | 50% | 1% | 1% | 50% | 50% |
| fluoroacetic | | | | | | |
| acid | | | | | | |
| solution | | | | | | |
| acetonitrile | 50% | 50% | 99% | 99% | 50% | 50% |
| (HPLC) | | | | | | |
| flow rate | 0.5 ml/min | 0.5 ml/min | 0.5 ml/min | 0.5 ml/min | 0.5 ml/min | 0.5 ml/min |
| wavelength | 210 nm | 210 nm | 210 nm | 210 nm | 210 nm | 210 nm |

Take the precursor 3 in the reaction 1 as an example, it's N-[2-((Triphenylmethyl)thio)ethyl] [2-((triphenylmethyl)thio)ethylamino]acetamide and having a structural formula:

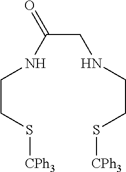

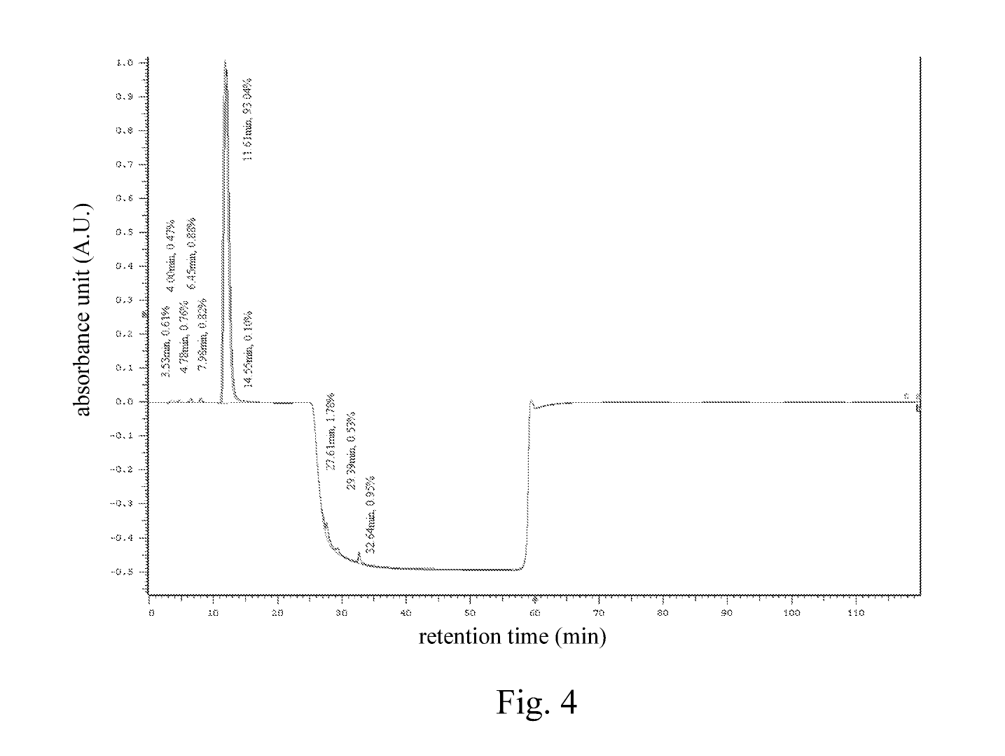

The analysis of the precursor 3 is performed in a 2.0 ml brown vial. First weight 3.8 mg precursor 3 and add 1.8 ml acetonitrile (HPLC). Firstly use 60% acetonitrile/40%, 0.1% trifluoroacetic acid solution as a first eluent and wait for 20 minutes. Then the first eluent is replaced by a second eluent containing 99% acetonitrile/1%, 0.1% trifluoroacetic acid solution in 60 seconds and wait for 30 minutes. Next the second eluent is replaced by the first eluent, 60% acetonitrile/40%, 0.1% trifluoroacetic acid solution, in 60 seconds and wait for 68 minutes. The retention time of the main signal (the precursor 3) is about 11.61 minutes. Please refer to the following table 3 and the chromatograph shown in FIG. 4.

TABLE 3

| H₃-L, | | | | | | |
|---|---|---|---|---|---|---|
| precursor 3 | 0.0 Min | 20.0 min | 21.0 min | 51.0 min | 52.0 Min | 120.0 min |
| 0.1% tri- | 40% | 40% | 1% | 1% | 40% | 40% |
| fluoroacetic | | | | | | |
| acid | | | | | | |
| solution | | | | | | |
| acetonitrile | 60% | 60% | 99% | 99% | 60% | 60% |
| (HPLC) | | | | | | |
| flow rate | 0.5 ml/min | 0.5 ml/min | 0.5 ml/min | 0.5 ml/min | 0.5 ml/min | 0.5 ml/min |
| wavelength | 210 nm | 210 nm | 210 nm | 210 nm | 210 nm | 210 nm |

Take the precursor 5, H₃-MN-16-Et, in the reaction 2 as an example, it's N-[2-((Triphenylmethyl)thio)ethyl]-3-aza-18-ethyloxycarbonyl-3-[2-((triphenylmethyl)thio)-ethyl]octadecanamide and having a structural formula:

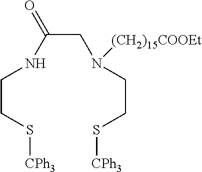

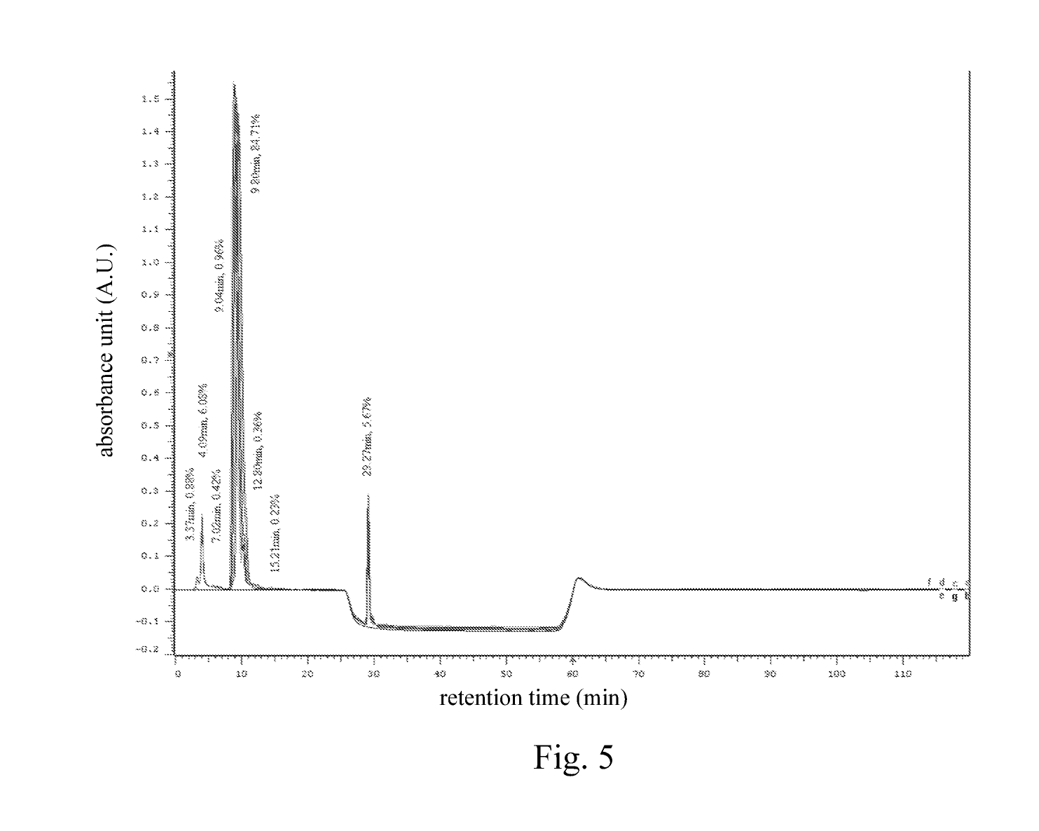

The analysis of the precursor 5 is performed in a 2.0 ml brown vial. First weight 5.3 mg precursor 5 and add 1.8 ml acetonitrile (HPLC). Firstly use 85% acetonitrile/15%, 0.1% trifluoroacetic acid solution as a first eluent and wait for 20 minutes. Then the first eluent is replaced by a second eluent containing 99% acetonitrile/1%, 0.1% trifluoroacetic acid solution in 60 seconds and wait for 30 minutes. Next the second eluent is replaced by the first eluent, 85% acetonitrile/15%, 0.1% trifluoroacetic acid solution, in 60 seconds and wait for 68 minutes. The retention time of the main signal (H₃-MN-16-Et) is about 9.8 minutes. Please refer to the following table 4 and the chromatograph shown in FIG. 5.

TABLE 4

| H₃-MN-16- | | | | | | |
|---|---|---|---|---|---|---|
| Et, | | | | | | |
| precursor 5 | 0.0 Min | 20.0 min | 21.0 min | 51.0 min | 52.0 Min | 120.0 min |
| 0.1% tri- | 15% | 15% | 1% | 1% | 15% | 15% |
| fluoroacetic | | | | | | |
| acid | | | | | | |
| solution | | | | | | |
| acetonitrile | 85% | 85% | 99% | 99% | 85% | 85% |
| (HPLC) | | | | | | |
| flow rate | 0.5 ml/min | 0.5 ml/min | 0.5 ml/min | 0.5 ml/min | 0.5 ml/min | 0.5 ml/min |
| Wavelength | 210 nm | 210 nm | 210 nm | 210 nm | 210 nm | 210 nm |

Take ReO-MN-16-Et in the reaction 3 as an example, it's [N-(2-thioethyl)-3-aza-19-ethyloxycarbonyl-3-(2-thioethyl)-octadecanamido]oxorhenium and having a structural formula:

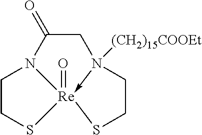

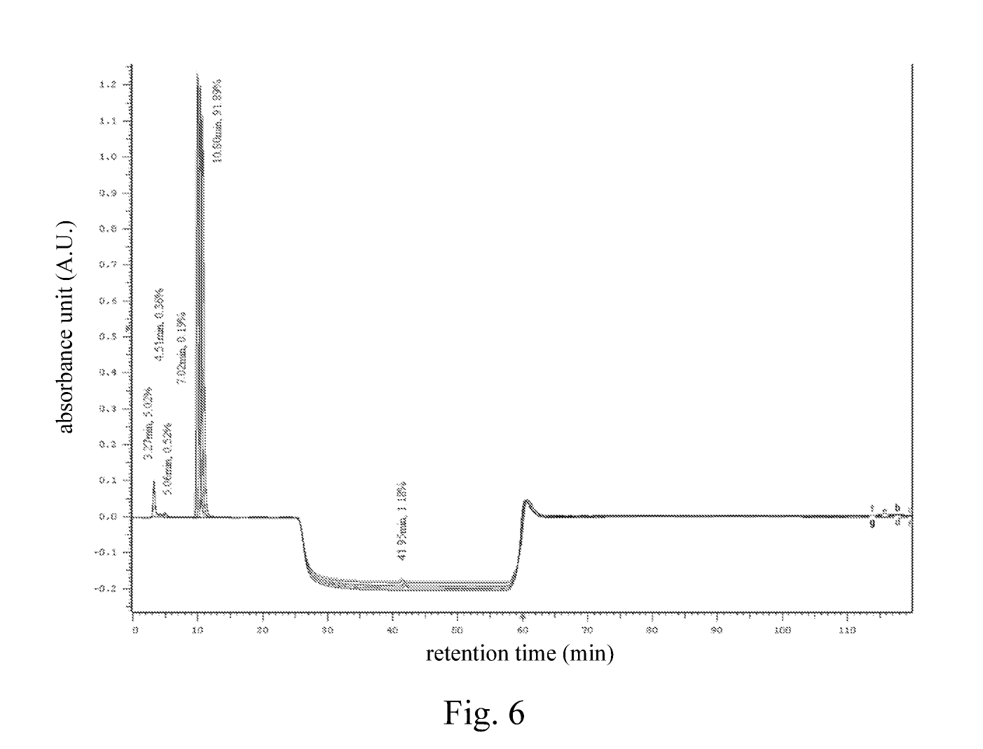

The analysis of ReO-MN-16-Et in the reaction 3 is performed in a 2.0 ml brown vial. First weight 6.9 mg ReO-MN-16-Et and add 1.8 ml acetonitrile (HPLC). Firstly use 80% acetonitrile/20%, 0.1% trifluoroacetic acid solution as a first eluent and wait for 20 minutes. Then the first eluent is replaced by a second eluent containing 99% acetonitrile/1%, 0.1% trifluoroacetic acid solution in 60 seconds and wait for 30 minutes. Next the second eluent is replaced by the first eluent, 80% acetonitrile/20%, 0.1% trifluoroacetic acid solution, in 60 seconds and wait for 68 minutes. The retention time of the main signal (ReQ-MN-16-Et) is about 9.8 minutes. Please refer to the following table 5 and the chromatograph shown in FIG. 6.

TABLE 5

| ReO-MN- | | | | | | |
|---|---|---|---|---|---|---|
| 16-Et, 8 | 0.0 Min | 20.0 min | 21.0 Min | 51.0 min | 52.0 Min | 120.0 min |
| 0.1% tri- | 20% | 20% | 1% | 1% | 20% | 20% |
| fluoroacetic | | | | | | |
| acid | | | | | | |
| solution | | | | | | |
| acetonitrile | 80% | 80% | 99% | 99% | 80% | 80% |
| (HPLC) | | | | | | |
| flow rate | 0.5 ml/min | 0.5 ml/min | 0.5 ml/min | 0.5 ml/min | 0.5 ml/min | 0.5 ml/min |
| wavelength | 210 nm | 210 nm | 210 nm | 210 nm | 210 nm | 210 nm |

In the above embodiments, the column is equilibrated with the starting ratio of acetonitrile and trifluoroacetic acid solution for at least 2 hours before performing analysis of each sample. Then use acetonitrile (HPLC) as a blank sample to be analyzed for at least 3 times. Compare the three test results of the blanks to confirm that there is no signal from residues of the previous analysis. Next the sample is analyzed. Thereby the accuracy of the analysis is ensured.

During the above analysis process, the flow rate is 0.5 ml/min for reducing the number of the times the eluent being added and further preventing baseline drift caused by bubbles. The retention time of the main component can be controlled within 6 minutes to 12 minutes once the analysis is performed under the flow rate of 0.5 ml/min. Thus not only the components of a mixture are separated, tailing caused by diffusion effect can also be avoided. The diffusion effect is resulted from long retention time. On the other hand, a higher flow rate results in increased amount of waste liquid and the analysis cost is raised.

In summary, the present invention changes the polarity of eluents compared with the conventional technique that uses the eluent with fixed polarity. The eluent containing a high ratio of acetonitrile is used to wash out residues in the column. Thus signal will not be overestimated or underestimated owing to existence of the impurities. The accuracy and reproducibility of the analysis result are increased. Moreover, the next analysis will not be affected by residual impurities of the previous analysis. The present invention uses an optimal flow rate to perform the analysis. Thus not only the volume of the eluents required is reduced, the analytes are also separated effectively. The tailing of the peak is eliminated.

In order to get or enhance the color, people skilled in the art can produce colored substrates according to the method of the present invention and followed by other treatments including painting, dyeing, etc.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A high performance liquid chromatography method for analysis of a MN diagnostic and therapeutic ligand which names N-(2-thioethyl)-3-aza-19-ethyloxycarbonyl-3-(2-thioethyl)-octadecanamido]oxorhenium complex having a following structural formula A 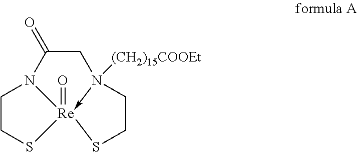
comprising the steps of:
placing a MN diagnostic and therapeutic ligand into a chromatography column; and
running a mobile phase elution of the MN diagnostic and therapeutic ligand and using an ultraviolet (UV) detector to record a chromatogram; wherein the step of running a mobile phase elution includes the steps of first using a first eluent to elute the MN diagnostic and therapeutic ligand, then using a second eluent to elute the MN diagnostic and therapeutic ligand and lastly using the first eluent again to elute the MN diagnostic and therapeutic ligand;
wherein both the first eluent and the second eluent include acetonitrile and a trifluoroacetic acid solution; a volume ratio of the acetonitrile in the second eluent is higher than a volume ratio of the acetonitrile in the first eluent.

2. The method as claimed in claim 1, wherein a weight percent of the trifluoroacetic acid solution is ranging from 0.1% to 1%.

3. The method as claimed in claim 1, wherein a volume ratio of the acetonitrile in the first eluent is 35˜85%.

4. The method as claimed in claim 1, wherein a volume ratio of the acetonitrile in the second eluent is 97˜99%.

5. The method as claimed in claim 1, wherein a flow rate in the mobile phase elution is ranging from 0.5 ml/min to 1 ml/min.

6. The method as claimed in claim 1, wherein in the step of using a first eluent to elute the MN diagnostic and therapeutic ligand, time required for the step is at least 20 minutes.

7. The method as claimed in claim 1, wherein in the step of using a second eluent to elute the MN diagnostic and therapeutic ligand, time required for the step is at least 20 minutes.

8. The method as claimed in claim 1, wherein in the step of lastly using the first eluent again to elute the MN diagnostic and therapeutic ligand, time required for the step is at least 60 minutes.

9. The method as claimed in claim 1, wherein a detection wavelength of the UV detector is 210 nm.

10. A high performance liquid chromatography method for analysis of MN diagnostic and therapeutic ligand precursors, wherein the MN diagnostic and therapeutic ligand is N-(2-thioethyl)-3-aza-19-ethyloxycarbonyl-3-(2-thioethyl)-octadecanamido]oxorhenium complex having a following structural formula A of: 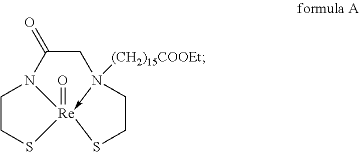
wherein the MN diagnostic and therapeutic ligand precursor is selected from the group consisting of 2-[(Triphenylmethyl)thio]ethylamine, N-[2-((Triphenyl-methyl)thio)ethyl]chloroacetamide, N-[2-((Triphenyl-methyl)thio)ethyl] [2-((triphenylmethyl)thio)ethylaminodacetamide and N-[2-((Triphenylmethyl)thio)ethyl]-3-aza-18-ethyloxycarbonyl-3-[2-((triphenylmethyl)thio)-ethyl]octadecanamide, comprising the steps of:
placing a MN diagnostic and therapeutic ligand precursor into a chromatography column; and
running a mobile phase elution of the MN diagnostic and therapeutic ligand precursor and using an ultraviolet (UV) detector to record a chromatogram; wherein running a mobile phase elution includes the steps of first using a first eluent to elute the MN diagnostic and therapeutic ligand precursor, then using a second eluent to elute the MN diagnostic and therapeutic ligand precursor and lastly using the first eluent again to elute the MN diagnostic and therapeutic ligand precursor;
wherein both the first eluent and the second eluent include acetonitrile and a trifluoroacetic acid solution; a volume ratio of the acetonitrile in the second eluent is higher than a volume ratio of the acetonitrile in the first eluent.

11. The method as claimed in claim 10, wherein a weight percent of the trifluoroacetic acid solution is ranging from 0.1% to 1%.

12. The method as claimed in claim 10, wherein a volume ratio of the acetonitrile in the first eluent is 35˜85%.

13. The method as claimed in claim 10, wherein a volume ratio of the acetonitrile in the second eluent is 97˜99%.

14. The method as claimed in claim 10, wherein a flow rate in the mobile phase elution is ranging from 0.5 ml/min to 1 ml/min.

15. The method as claimed in claim 10, wherein in the step of using a first eluent to elute the MN diagnostic and therapeutic ligand precursor, time required for the step is at least 20 minutes.

16. The method as claimed in claim 10, wherein in the step of using a second eluent to elute the MN diagnostic and therapeutic ligand precursor, time required for the step is at least 20 minutes.

17. The method as claimed in claim 10, wherein in the step of lastly using the first eluent again to elute the MN diagnostic and therapeutic ligand precursor, time required for the step is at least 60 minutes.

18. The method as claimed in claim 10, wherein a detection wavelength of the UV detector is 210 nm.
